(19) United States
(12) Patent Application Publication
(10) Pub. No.: US 2008/0036207 A1
(43) Pub. Date: Feb. 14, 2008

(54) Connector of Flexible Pipe

(76) Inventor: Jin Lim Choi, Sungnam-si (JP)

Correspondence Address: BIRCH STEWART KOLASCH & BIRCH, PO BOX 747, FALLS CHURCH, VA, 22040-0747, US

(21) Appl. No.: 11/629,817

(22) PCT Filed: Jun. 16, 2005
(86) PCT No.: PCT/KR05/01842

§ 371 Date: Dec. 18, 2006

(30) Foreign Application Priority Data
Jun. 18, 2004 (KR) 10-2004-0045527
Jul. 1, 2004 (KR) 10-2204-0051161
Mar. 28, 2005 (KR) 10-2005-0025551

(51) Int. Cl. F16L 33/00

(52) U.S. Cl. 285/323; 285/382.7

(57) ABSTRACT

A connector of flexible pipe according to the present invention includes a flexible pipe; a fastening nut in which the flexible pipe is inserted; a latching ring having an inner portion received in a valley section of the flexible pipe and an outer portion extruded outward from a thread section of the flexible pipe for preventing the fastening nut from separating from the flexible pipe; and a socket tube screw combined with the fastening nut for pressurizing and transforming an end portion of the flexible pipe toward the latching ring. Accordingly, the coupler structure of the flexible pipe is conveniently achieved as well as the flexible pipe can be coupled easily by cutting in a desired length, and since there is no need to perform the process for machining the coupling portion, a cost for coupling the members is saved.

### TECHNICAL FIELD

The present invention relates to a connector of flexible pipe, and more particularly, to a connector of flexible pipe which can couple easily a flexible pipe to a socket tube by means of only combining force of a fastening nut.

### BACKGROUND ART

FIG. 1 is an exploded perspective view showing a connector of flexible pipe according to the prior art and FIG. 2 is a front view, partially in section, showing the connector of flexible pipe shown in FIG. 1.

As shown in FIG. 1 and FIG. 2, a connector of flexible pipe according to the prior art comprises a flexible pipe 1, a socket tube 3 to be located face to face with and coupled to the flexible pipe 1 and a fastening nut 2 coupling the flexible pipe 1 to the socket tube 3.

On the other hand, although not showing in the drawings, a valve or another tube or the like is connected to a side of the socket tube 3.

The flexible pipe 1 comprises a non-corrugated portion 1a formed at a

portion to which the socket tube 3 is coupled and a flare-shaped outer portion 1b formed at an end of the non-corrugated portion 1a, the outer portion is latched to an inner surface of the fastening nut 2.

In the socket tube 3, a male thread 3a to be screw combined with the fastening nut 2 is formed at a front side and a taper section 3b is formed at a front end portion. A diameter of the taper section is gradually decreased toward an end so that taper section 3b is located face to face with the outer portion 1b of the flexible pipe 1.

In the fastening nut 2, a female thread 2a to be screw combined with the male thread 3a formed on an outer circumference of the front side of the socket tube 3 is formed on an inner circumference surface and a latching section 2b is formed at one side. The latching section has an inclined surface such that the latching section 2b is latched to the outer portion 1b of the flexible pipe 1.

In the conventional connector of flexible pipe structure, the non corrugated portion 1a of the flexible pipe 1 is inserted in the fastening nut 2, the outer portion 1b of the flexible pipe is then machined into a flare shape for preventing the fastening nut 2 from the flexible pipe, and so a set of coupler is formed.

In the state that the fastening nut 2 is assembled to the flexible pipe 1 as described above, once the socket tube 3 is located face to face with the fastening nut 2 and the fastening nut 2 is then rotated in order to couple the socket tube 3 to the flexible pipe, the taper section 3b of the socket tube 3 is pressurized to the outer portion 1b of the flexible pipe 1, and so the socket tube and the flexible pipe are coupled to each other.

In the conventional connector of flexible pipe structure, however, in order to couple the flexible pipe 1 and the socket tube 3, the non corrugated section 1a is formed on the flexible pipe 1, the non corrugated section is inserted in the fastening nut 2 and the corrugation tub coupler is then assembled as one set. Therefore, the connector of flexible pipe structure has the problems that the flexible pipe 1 which was machined in advance should be prepared, a portion of the flexible pipe 1 to be coupled should be machined additionally when a different length of the flexible pipe 1 is decided, if necessary, and so it is not easy to adjust a length of the flexible pipe.

Also, in the conventional connector of flexible pipe structure, the outer portion 1b of the flexible pipe 1 and the taper section 3b of the socket tube 3 are contacted airtightly and connected to each other by a combining force of the fastening nut 2. However, in only state that the latching section 2b of the fastening nut 2, the outer portion 1b of the flexible pipe 1 and the taper section 3b of the socket 3 are corresponded precisely to each other, an airtight structure having a sufficient reliability can be secured. Therefore, there are problems that the above sections should be machined precisely in advance and much manufacturing cost is required due to such precision machine.

### DISCLOSURE OF INVENTION

### Technical Problem

The present invention is conceived to solve the above mentioned problems, an object of the present invention is to provide a corrugation coupling structure in which a fastening nut is assembled to a flexible pipe through a latching ring without a separate process for machining an end portion of the corrugation to be coupled to a socket tube and the socket tube is coupled to the flexible pipe by a combining force of the fastening nut so that a corrugation coupling structure is simplified, the corrugation to be coupled is cut in a desired length to enable the flexible pipe to couple easily to the socket tube and a cost for coupling the members can be saved.

Another object of the present invention is to provide a corrugation coupling structure in which the fastening nut is assembled to the flexible pipe by means of latching ring and then the socket tube can be coupled to the fastening nut in the state that a heat-resistive packing member is placed in the fastening nut, and so the flexible pipe and the socket can be coupled easily to each other and a reliability of the heat-resistive sealing structure becomes high.

Yet another object of the present invention is to provide a corrugation coupling structure in which a thickness of an outer portion of the latching ring which is not received in the flexible pipe is thicker than that of the other portion which received in the flexible pipe, and so the latching ring is not transformed and a great supporting force can be provided when an end portion of the flexible pipe is pressurized and transformed by the fastening nut.

### Technical Solution

The connector of flexible pipe according to the present invention for achieving the above objects comprises a flexible pipe; a fastening nut in which the flexible pipe is inserted; a latching ring having an inner portion received in a valley section of the flexible pipe and an outer portion extruded outward from a thread section of the flexible pipe for preventing the fastening nut from separating from the flexible pipe; and a socket tube screw combined with the fastening nut for pressurizing and transforming an end portion of the flexible pipe toward the latching ring.

Also, the connector of flexible pipe according to the present invention is characterized in that a thickness of an outer side of the latching ring is thicker than

that of an inner side to be received in a valley section of the flexible pipe.

In addition, the connector of flexible pipe according to the present invention is characterized in that the coupler further comprises a sealing member performing the sealing function is placed between the flexible pipe and the fastening nut.

### ADVANTAGEOUS EFFECTS

The connector of flexible pipe according to the present invention is advantageous in that a coupling structure of the flexible pipe is formed conveniently and the flexible pipe can be coupled easily by cutting in a desired length, and there is no need to perform the process for machining the coupling portion, and so a cost for coupling the members is saved, the connector of flexible pipe has a sufficient heat resistance, a sealing effect and a reliability of the sealing structure is increased.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is an exploded perspective view showing a connector of flexible pipe according to the prior art;

FIG. 2 is a front view, partially in section, showing the connector of flexible pipe of FIG. 1;

FIG. 3 is an exploded perspective view showing a connector of flexible pipe according to the first embodiment of the present invention;

FIG. 4 is a front view, partially in section, in which a socket tube is shown prior to being coupled in the connector of flexible pipe shown in FIG. 3;

FIG. 5 is a front view, partially in section, in which the socket tube is shown after being coupled in the connector of flexible pipe shown in FIG. 3;

FIG. 6 is an exploded perspective view showing a connector of flexible pipe according to the second embodiment of the present invention;

FIG. 7 is a front view, partially in section, in which the socket tube is shown prior to being coupled in the connector of flexible pipe shown in FIG. 6;

FIG. 8 is a front view, partially in section, in which the socket tube is shown after being coupled in the connector of flexible pipe shown in FIG. 6; and

FIG. 9 is a sectional view showing a connector of flexible pipe according to the third embodiment of the present invention.

### BEST MODE FOR CARRYING OUT THE INVENTION

Hereinafter, the embodiments of the present invention will be described in detail with reference to accompanying drawings.

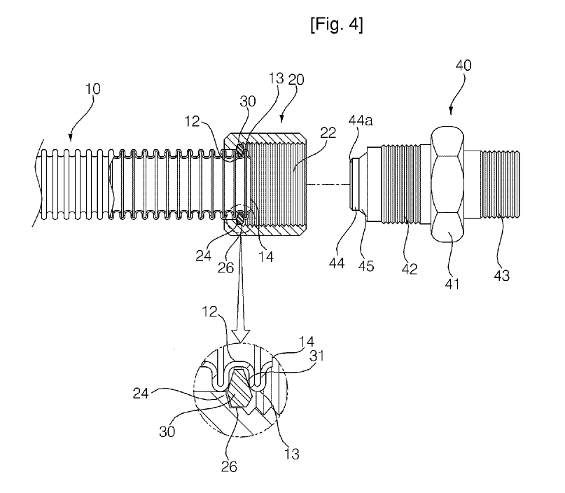

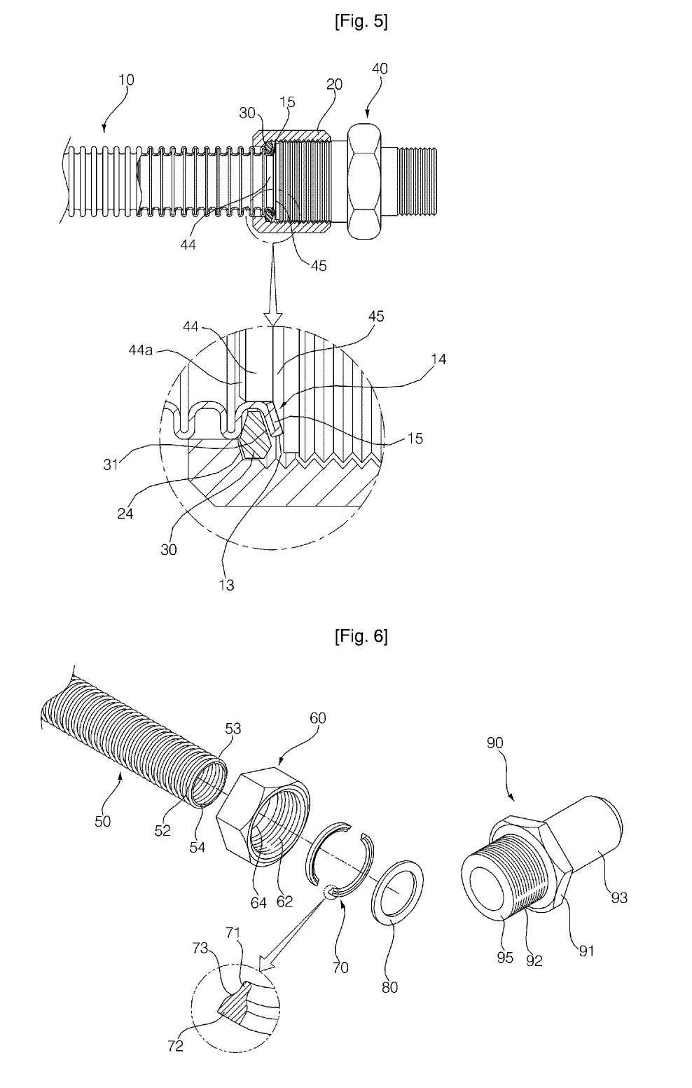

FIG. 3 is an exploded perspective view showing a connector of flexible pipe according to the first embodiment of the present invention, FIG. 4 is a front view, partially in section, in which a socket tube is shown prior to being coupled in the connector of flexible pipe shown in FIG. 3 and FIG. 5 is a front view, partially in section, in which the socket tube is shown after being coupled in the connector of flexible pipe shown in FIG. 3.

As shown in FIG. 3 and FIG. 4, the connector of flexible pipe according to the first embodiment of the present invention comprises a tube 10 having an outer surface on which a continuous corrugation is formed; a fastening nut 20 in which the flexible pipe 10 is inserted; a latching ring 30 having an inner portion received in a valley section 12 of the flexible pipe 10 and an outer portion extruded outward for preventing the fastening nut 20 from separating from the flexible pipe 10; and a socket tube 40 contacted closely with the latching ring by a combining force of the fastening nut 20 and pressurizing and transforming a shape of an end portion 14 of the flexible pipe 10 into a flare shape between the latching ring 30 and the socket tube.

Major structural elements constituting the metal joint type connector of flexible pipe of the present invention as above is described as follows.

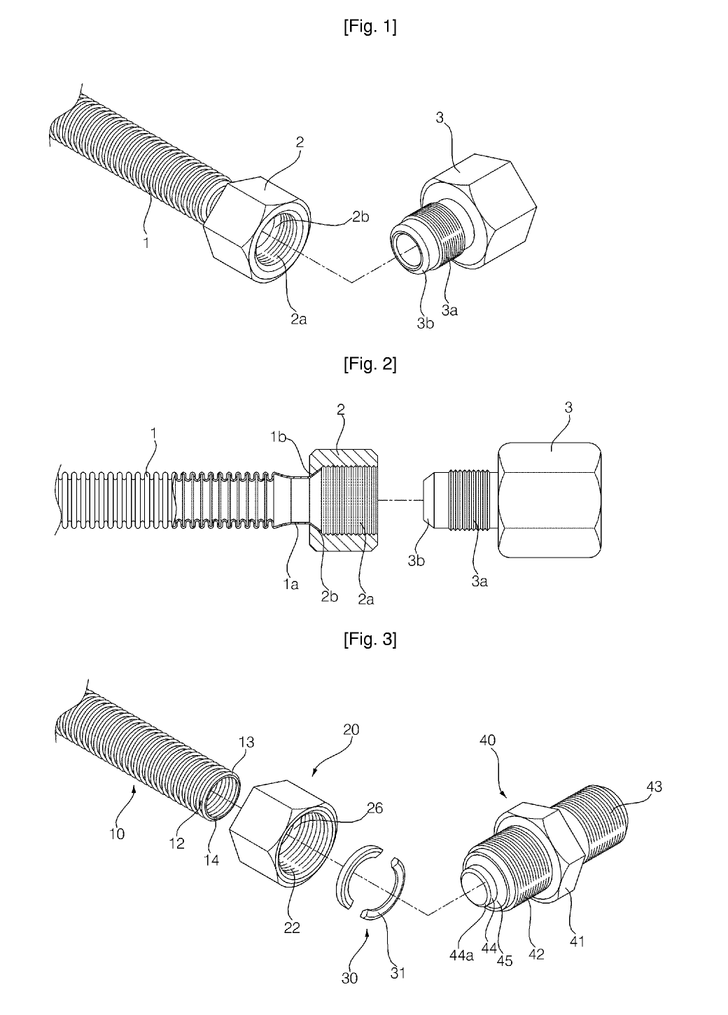

First, compared with the conventional flexible pipe 1 shown in FIG. 1, additional no-corrugated section is not formed on the flexible pipe 10, this flexible pipe is formed by forming a continuous corrugation on a tube. Due to this corrugation structure, therefore, valley sections and thread section are continuously formed, an inner portion of the latching ring 30 is received in the valley section 12.

In the flexible pipe 10, when the end portion 14 is pressurized between the latching ring 30 and the socket tube 40, the end portion 14 is compressed with the thread section 13 adjacent to the end portion as a center, and so the end portion is transformed into a sealing section 15 which has a flare shape with twofold structure as shown in FIG. 5.

Next, the fastening nut 20 is perforated in a longitudinal direction thereof, an inner diameter of one side is larger than a maximum diameter of the flexible pipe 10 obtained by the thread section 13, and so the flexible pipe 10 can be inserted in the fastening nut. An inner diameter of one end portion of the fastening nut is larger than that of an inner side to form a latching section 24 with which the latching ring 30 is contacted. And, as shown in FIG. 4, an immediate inside of the latching section 24 functions as a seat section 26 with which an outer surface of the latching ring 30 is contacted.

A female screw 22 is formed on an inner surface of the fastening nut 20 from the seat section 26 to the other end portion, the socket tube 40 is screw combined with this female screw.

Next, it is desirable that the latching ring 30 is made from the metal such as stainless steel or brass alloy and the like, the latching ring is made in a single body or divided into two or more segments for mounting easily on an outer circumference surface of the flexible pipe 10. As shown in FIG. 3, this embodiment illustrates that the latching ring is divided into two segments and two segments can be received in both sides of the valley section 12 of the flexible pipe 10, respectively.

The latching ring 30 as described above prevents the fastening nut 20 from separating from the flexible pipe 10 and supports the flexible pipe 10 for transforming the thread portion 13 of the end portion 14 into the flare shaped sealing section 15 when the socket tube 40 is contacted closely with the latching ring. In the latching ring 30, as shown in the enlarged sectional view of FIG. 4, a thickness of an outer side portion is thicker than that of an inner side and the inner side has a V-shaped section.

In particular, an inner side of the latching ring 30 is formed into an inclined supporting surface 31 so as to enable the end portion of the flexible pipe 10 to be transformed into the flare type sealing section 15 when the socket tube 40 is screw combined with the fastening nut 20.

Next, in the socket tube 40, a hexagonal head 41 and a male screw 43 are formed at a rear side and a male screw 42 to be screw combined with the fastening nut 20 is formed at a frond side. A pressurizing section 45 with an inclined surface is formed at a front side of the socket tube 40. An outer diameter of the pressurizing section is gradually decreased toward an end, and so the pressurizing section is contacted completely with the flare type sealing section 15 of the flexible pipe 10.

In particular, in the socket tube 40, an inserting section 44 having a straight tube shape is formed at a front end portion of the pressurizing section 45 and an end portion 44a of the inserting section 44 has a taper shape. Once the socket tube 40 is screw combined with the fastening nut 20, the end portion 14 of the flexible pipe 10 is bent inward toward a center axis of the flexible pipe 10 by the inserting section 44 of the socket tube 40 and the end portion 14 is transformed into the flare type sealing section 15. Consequently, the inserting section makes the sealing section outstretch outward.

An operation of the connector of flexible pipe according to the first embodiment of the present invention constituted as described above is described as follows.

First, an assembling sequence for coupling the flexible pipe 10 is described. After an end portion of the flexible pipe 10 is inserted in the fastening nut 20, once the fastening nut 20 is pulled and moved to an end portion of the flexible pipe 10 in the state that the latching ring 30 consisted of a single segment or two segments is closely received in the valley section 12 located at an end portion of the flexible pipe 10, the latching section 24 of the fastening nut 20 is latched to the latching ring 30, and so the fastening nut 20 is not separated from the flexible pipe 10.

At this time, since the latching ring 30 is also placed at an inner side of the fastening nut 20 as shown in FIG. 4, it is possible to maintain the state that the latching ring 30 is received in the valley section 12 of the flexible pipe 10 as it is.

After this, once the socket tube 40 is located face to face with the other side of the fastening nut 20 and the fastening nut 20 is rotated in order to couple the flexible pipe 10, the socket tube 40 is approached to the flexible pipe 10, the socket tube 40 is contacted to the latching ring by a combining force of the fastening nut 20 and the socket tube 40 pressurizes the end portion 14 of the flexible pipe 10 to transform the end portion into the flare type sealing section 15 as shown in FIG. 5.

That is, first of all, the inserting section 44 of the socket tube 40 is inserted in the flexible pipe 10 when the socket tube 40 is contacted closely with the flexible pipe 10, and once the socket tube 40 is moved farther toward the latching ring 30 in the state the inserting section 44 was inserted in the flexible pipe 10, the thread section 13 of the end portion 14 of the flexible pipe 10 is bent to a central axis of the flexible pipe 10 and the end portion 14 of the flexible pipe 10 is pressurized between the pressurizing surface 45 of the socket tube 40 and the inclined supporting surface 31 of the latching ring 30, and so the flare type sealing section 15 with the twofold structure is formed.

Here, the flare type sealing section 15 of the flexible pipe 10 is placed between the inclined supporting surface 31 of the latching ring 31 and the pressurizing surface 45 (inclined at the angle which is same as an inclined angle of the latching ring 30) of the socket tube 40, and so the sealing section 15 performs the sealing function.

As described above, if the connector of flexible pipe is manufactured by cutting the flexible pipe 10 in a desired length, assembling the flexible pipe 10, the fastening nut 20 and the latching ring 30 and screw combining the fastening nut 20 with the socket tube 40, since there is no need to machine a coupling section of the flexible pipe 10 in advance, additional equipment is not required and the flexible pipe 10 can be coupled conveniently and easily.

Also, since the flare type sealing section 15 of the flexible pipe 10 has twofold structure and is placed between the supporting surface 31 of the latching ring 30 and the pressurizing surface 45 of the socket tube 40, it is possible to secure the sealing structure having the greater reliability.

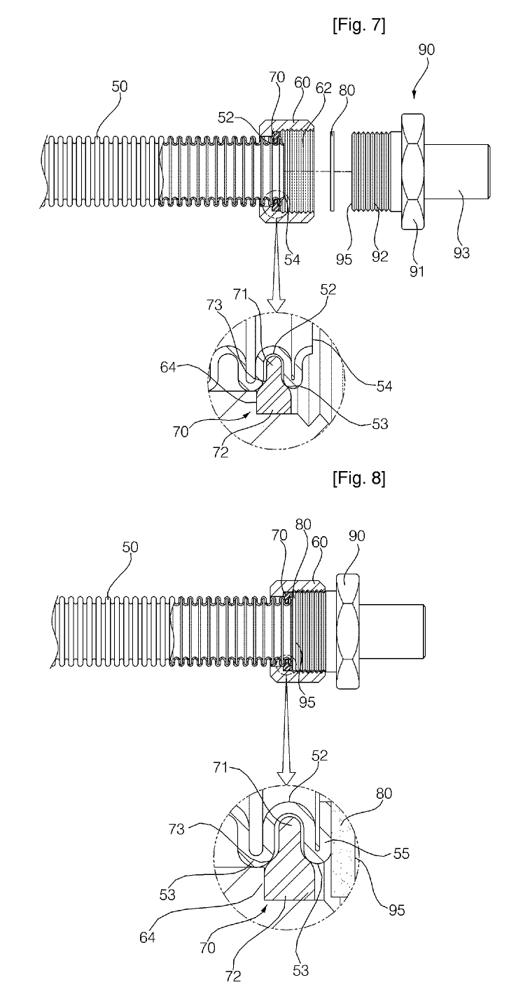

FIG. 6 is an exploded perspective view showing a connector of flexible pipe according to the second embodiment of the present invention, FIG. 7 is a front view, partially in section, in which the socket tube is shown prior to being coupled in the connector of flexible pipe shown in FIG. 6 and FIG. 8 is a front view, partially in section, in which the socket tube is shown after being coupled in the connector of flexible pipe shown in FIG. 6.

As shown in FIG. 6, the connector of flexible pipe according to the second embodiment of the present invention comprises a tube 50 having an outer surface on which a continuous corrugation is formed; a fastening nut 60 in which the flexible pipe 50 is inserted, the fastening nut having a latching section 64 formed on an inner surface thereof; a latching ring 70 having an inner portion received in a valley section 52 of the flexible pipe 50 and an outer portion extruded outward and contacted with the latching section 64 of the fastening nut 60 for preventing the fastening nut 60 from separating from the flexible pipe 50; a socket tube 90 being moved by a combining force of the fastening nut 60 to pressurize an end portion 54 of the flexible pipe 50 to the latching ring 70 and transform an end portion 54; and a packing member 80 placed between the socket tube 90 and the end portion 54 of the flexible pipe 50 to perform the seal function.

Major structural elements constituting the connector of flexible pipe according to the second embodiment of the present invention as above is described as follows.

First, like the first embodiment, due to the corrugation structure, valley sections and thread section are continuously formed on an outer surface of the flexible pipe 50, and an inner portion of the latching ring 70 is received in the valley section 52.

In the flexible pipe 50, when the end portion 54 is pressurized between the latching ring 70 and a pressurizing section 95 the socket tube 90, the end portion 54 is compressed with the thread section 53 as a center, and so the end portion is transformed into a pressurizing/transforming section 55 which has a flat shape with twofold structure as shown in FIG. 8.

On the other hand, the fastening nut 60 is perforated in a longitudinal direction thereof, an inner diameter of one side is larger than a maximum diameter of the flexible pipe 50 obtained by the thread section 53, and so the flexible pipe 50 can be inserted in the fastening nut. An inner diameter of one end portion of the fastening nut is larger than that of an inner side to form a latching section 64 with which the latching ring 70 is contacted.

Also, a female screw 62 is formed on an inner surface of the fastening nut 60 from the latching section 64 to the other end portion, the socket tube 90 is screw combined with this female screw.

Next, it is desirable that the latching ring 70 is made from the metal such as stainless steel or brass alloy and the like, the latching ring is made in a single body or divided into two or more segments for mounting easily on an outer circumference surface of the flexible pipe 50. As shown in FIG. 6, this embodiment illustrates that the latching ring is divided into two segments and two segments can be combined with both sides of the flexible pipe 50, respectively.

The latching ring 70 as described above prevents the fastening nut 60 from separating from the flexible pipe 50 and supports the flexible pipe 50 for transforming the end portion 54 into the pressurizing/transforming section 55 when the pressurizing section 95 of the socket 90 is contacted closely with the latching ring.

In particular, it is desirable that the latching ring 70 is consisted of an inner portion 71 to be received in the valley section 52 of the flexible pipe 50 and an outer portion 72 protruded outward from the inner portion 71 in a radial direction. Also, it is desirable that a thickness of the outer portion 72 is thicker than that of the inner portion 71.

Here, the outer portion 72 is expanded in both side direction of the inner portion 71 so that the outer portion 72 is placed between both valley sections 53.

And, since a boundary portion 73 between the inner portion 71 and the outer portion 72 has a rough inclined structure, it is desirable that this boundary portion 73 has a curved shape corresponding to a curved surface of the valley section 53 of the flexible pipe 50.

In the socket tube 90, a hexagonal head 91 and a coupling tube section 93 are formed at a rear side and a male screw 92 to be screw combined with the fastening nut 60 is formed at a frond side. The flat shaped pressurizing section 95 is formed at a front side of the socket tube 40 and contacted closely with the pressurizing/transforming section 55 of the flexible pipe 50.

The packing member 80 has a circular ring structure and is placed between the pressurizing/transforming section 55 of the flexible pipe 50 and the pressurizing section 95 of the socket tube 90 when the flexible pipe 50 is coupled, and so the packing member is contacted closely to surfaces of the pressurizing/transforming section 55 and the pressurizing section 95 to prevent the fluid flowing in the tubes from leaking from the tubes.

It is desirable that an asbestos free packing or a packing made from the soft metal, each of which having an excellent heat resistance, a high mechanical strength, an excellent corrosion resistance and wear resistance, is used as the packing member 80.

An operation of the connector of flexible pipe according to the second embodiment of the present invention constituted as described above is described as follows.

First, an assembling sequence for coupling the flexible pipe 50 is described. After an end portion of the flexible pipe 50 is inserted in the fastening nut 60, once the fastening nut 60 is pulled and moved to an end portion of the flexible pipe 50 in the state that the inner portion 71 of the latching ring 70 consisted of two segments is closely received in the valley section 52 located at an end portion of the flexible pipe 50, the latching section 64 of the fastening nut 60 is latched to the outer portion 72 of the latching ring 70, and so the fastening nut 60 is not separated from the flexible pipe 50,

At this time, since the latching ring 70 is also placed at an inner side of the fastening nut 60 as shown in FIG. 7, it is possible to maintain the state that the latching ring 70 is received in the valley section 52 of the flexible pipe 50 as it is.

After this, once the packing member 80 is placed in the fastening nut 60, the socket tube 90 is then located face to face with the other side of the fastening nut 60 and the fastening nut 60 is rotated in order to screw combine the fastening nut with the flexible pipe 50, due to a combining force of the fastening nut 60, the socket tube 90 makes the packing member 80 be contacted closely with the fastening ring 70 as shown in FIG. 7, and so the pressurizing/transforming section 55 is formed at an end portion of the flexible pipe 50.

That is, once the socket tube 90 is moved toward the flexible pipe 50 and the socket tube 90 is then contacted closely with the packing member 80, the end portion 54 of the flexible pipe 50 is bent with the valley section 53 as a center by the pressurizing section 95 of the socket tube 90 and is pressurized between the packing member 80 and the latching ring 70, and so the end portion 54 of the flexible pipe 50 is transformed into the pressurizing/transforming 55 with the two fold structure.

Here, along with the packing member 80, the pressurizing/transforming section 55 of the flexible pipe 50 performs the sealing function at a coupled portion of the flexible pipe 50 and the socket tube 90.

In particular, since the outer portion 72 of the latching ring 70 formed with a thicker thickness at the latching ring 70 is contacted with the latching section 64 of the fastening nut 60 when the pressurizing/transforming section 55 of the flexible pipe 50 is bent, a transformation of the latching ring 70 such as a bend is not generated and the pressurizing/transforming section 55 of the flexible pipe 50 is formed when a force is applied from the socket tube 90.

As described above, if the connector of flexible pipe is manufactured by cutting the flexible pipe 50 in a desired length, assembling the flexible pipe 50, the fastening nut 60 and the latching ring 70, placing the packing member 80 and screw combining the socket tube 90 with the flexible pipe 50 through the fastening nut 60, the socket tube 90 can be conveniently and easily coupled to the flexible pipe 50 without an additional process for forming and machining a coupling section of the flexible pipe 50 in advance and a special equipment.

Also, since the pressurizing/transforming 55 of the flexible pipe 50 has twofold structure and is contacted closely with the surfaces of the latching ring 70 and the socket tube 40 together with the packing member 80, it is possible to secure the sealing structure having the greater reliability.

In particular, since the latching ring 70 is not transformed when the pressurizing/transforming section 55 is formed by the outer portion 72 of the latching ring 70, the pressurizing/transforming section 55 can be formed by the greater supporting force, and so it is possible to form easily the pressurizing/transforming section 55 and realize the corrugation coupling structure having the greater reliability.

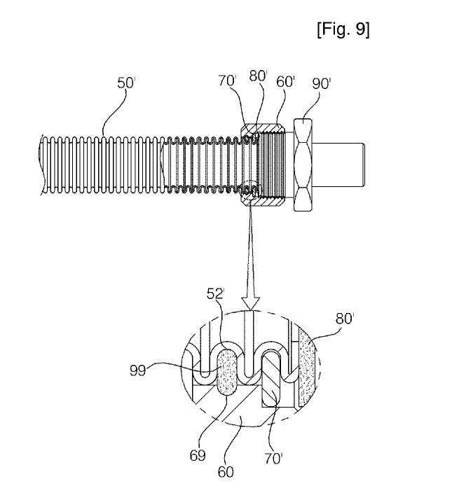

FIG. 9 is a sectional view showing a connector of flexible pipe according to the third embodiment of the present invention.

In the third embodiment of the present invention, a sectional surface of a latching ring 70 has a linear shape and an O-ring 99 which is a sealing member is inserted between a fastening nut 60 and a flexible pipe 50 to seal insides of the fastening nut and the flexible pipe 50′

In the third embodiment of the present invention as described above, in the case that a pitch between the thread sections of the flexible pipe 50 is narrow, a thick of the latching ring 70 to be received in a valley section 52 of the flexible pipe 50 becomes remarkably narrow, and so the latching ring does not have a sufficient rigidity in the case that the latching ring has a shape and structure which are same as those of the latching ring in the aforementioned embodiments.

Accordingly, a groove section 69 is formed on an inner circumference surface of the fastening nut 60 and the O-ring made from rubber and the like is inserted between the groove section 69 and the flexible pipe 50′ and so a sealing performance between the corrugation member 50 and the fastening nut 60′ can be enhanced.

It goes without saying that, in the third embodiment, a packing member 80 having the heat resistance and functioning as a seal member can be inserted between the socket tube 90′ and the flexible pipe 50′

### INDUSTRIAL APPLICABILITY

The connector of flexible pipe according to the present invention is advantageous in that since the fastening nut is assembled to the flexible pipe through the latching ring and an end portion of the flexible pipe is pressurized, the coupler structure of the flexible pipe is conveniently achieved as well as the flexible pipe can be coupled easily by cutting in a desired length, and since there is no need to perform the process for machining the coupling portion, a cost for coupling the members is saved, the connector of flexible pipe has a sufficient heat resistance.

Also, since the fastening nut is assembled to the flexible pipe through the latching ring for preventing the fastening nut from separating and then the socket tube can be coupled to the fastening nut in the state that the packing member having a heat resistance is placed in the fastening nut, a sealing effect of the connector of flexible pipe according to the present invention can be enhanced.

In addition, the connector of flexible pipe according to the present invention is advantageous in that since an end portion of the flexible pipe is pressurized and transformed into a twofold or more structure by the socket tube and seals a coupled portion of the flexible pipe when the flexible pipe and the socket tube are coupled, a reliability of the sealing structure is enhanced.

Further, the connector of flexible pipe according to the present invention is advantageous in that since a thickness of an outer portion of the latching ring which is not received in the valley section of the flexible pipe is thicker than that of the other portion, the connector of flexible pipe provides a great supporting force without a transformation of the latching ring when the end portion of the flexible pipe is pressurized and transformed by the socket tube, and so the corrugation coupler with a higher reliability can be secured.

It is intended that the embodiments of the present invention described above and illustrated in the drawings should not be construed as limiting the technical spirit of the present invention. The scope of the present invention is defined only by the appended claims. Those skilled in the art can make various changes and modifications thereto without departing from its true spirit. Therefore, various changes and modifications obvious to those skilled in the art will fall within the scope of the present invention.

1. A connector of flexible pipe is characterized in comprising:
a flexible pipe; a fastening nut in which the flexible pipe is inserted; a latching ring having an inner portion received in a valley section of the flexible pipe and an outer portion extruded outward from a thread section of the flexible pipe for preventing the fastening nut from separating from the flexible pipe; and a socket tube screw combined with the fastening nut for pressurizing and transforming an end portion of the flexible pipe toward the latching ring.

2. The connector of flexible pipe according to claim 1 is characterized in that the latching ring is formed of metal and is composed of a plurality of rings so as to be easily inserted into the flexible pipe.

3. The connector of flexible pipe according to claim 1 is characterized in that the latching ring and the socket tube have sloped surfaces at portions that deforms a leading edge of the flexible pipe.

4. The connector of flexible pipe according to claim 1 is characterized in that the socket has an insertion portion to be inserted into inner portion of the flexible pipe.

5. The connector of flexible pipe according to claim 1 is characterized in that the insertion portion is composed of a cylinder part with a constant diameter and a tapered part placed on the end of the cylinder part.

6. The connector of flexible pipe according to claim 1 is characterized in that a thickness of an outer side of the latching ring is thicker than that of an inner side to be received in a valley section of the flexible pipe.

7. The connector of flexible pipe according to claim 6 is characterized in that the outer sides of the latching ring expands toward the inner side of the latching ring.

8. The connector of flexible pipe according to claim 6 is characterized in that at least a side of the inner side of the latching has a sloped surface.

9. The connector of flexible pipe according to claim 6 is characterized in that the latching ring has a portion which is curved between the inner side and the outer side.

10. The connector of flexible pipe according to claim 1 is characterized in that the coupler further includes a sealing member between the flexible pipe and the fastening nut.

11. The connector of flexible pipe according to claim 1 is characterized in that the coupler further includes a packing member between an end portion of the flexible pipe and the socket.

12. The connector of flexible pipe according to claim 11 is characterized in that a side of the socket, with which the packing member is in contact, is planar.
